(19) United States
(12) Patent Application Publication
(10) Pub. No.: US 2014/0154929 A1
(43) Pub. Date: Jun. 5, 2014

(54) ELECTRICAL CONNECTOR

(71) Applicant: Molex Incorporated, Lisle, IL (US)

(72) Inventors: Hao YIN, Shanghai (CN); Chun-Guang Li, Shanghai (CN)

(21) Appl. No.: 13/904,692

(22) Filed: May 29, 2013

(30) Foreign Application Priority Data
May 31, 2012 (CN) 201210176728.0

(51) Int. Cl. H01R 13/46

(52) U.S. Cl. CPC H01R 13/46
USPC 439/660

(57) ABSTRACT

The present application relates to an electrical connector, the electrical connector is formed with a receiving space having an opening opened upwardly, the electrical connector comprises an insulative body, a plurality of terminals and a metal shell. The terminals are fixed to the insulative body. The metal shell is mounted to the insulative body. The metal shell comprises a resilient piece, the resilient piece protrudedly extends toward the receiving space, a distal end of the resilient piece comprises a first tab and a second tab, the first tab and the second tab extend downwardly respectively, the first tab is offset toward inside of the receiving space relative to the second tab, and an end edge of the second tab is lower than an end edge of the first tab.

### RELATED APPLICATIONS

This applications claims priority to Chinese Patent Application No. 201210176728.0, filed May 31, 2012, which is incorporated herein by reference in its entirety.

### FIELD OF THE PRESENT APPLICATION

The present application relates to an electrical connector, and more specifically to an electrical connector connecting a camera module.

### BACKGROUND OF THE PRESENT APPLICATION

FIGS. 1A-1C illustrate a camera module connector 1 and a latch element 11 thereof in the prior art. As shown in FIGS. 1A-1C, a latch element 11 extends obliquely and downwardly into a receiving space 13 for receiving a camera module 12. When the camera module 12 is inserted into the receiving space 13, a side surface of the camera module 12 would push the latch element 11 outwardly. When the latch element 11 is pushed outwardly, which is similar to a pendulum, a height of a distal end of the latch element 11 descends with it. When a descending distance of the distal end reaches G_{L}, the side surface of the camera module 12 no longer abuts against the latch element 11, the latch element 11 would rebound and enter into a recessed groove of the camera module 12 and abut against a bottom surface of the recessed groove. Generally, a rebound distance of the latch element 11 is about G_{L}, that is, the distal end of the latch element 11 returns to an initial height thereof. If a length of the latch element 11 is L and a swinging angle between a position where the latch element 11 is not pressed down and a position after the distal end is pressed down is 30 degree, the descending distance G_{L} may be about 0.14L. Furthermore, in order to press the camera module 12 down enough to make the latch element 11 rebound and enter into the recessed groove of the camera module 12, a reserve space G_{M} defined between the bottom surface of the receiving space 13 of the camera module connector 1 and a bottom surface of the camera module 12 mounted must be larger than the distance G_{L} a relative big mounting allowance. The camera module connector 1 need a relative high height due to the relative big mounting allowance, therefore it is difficult to meet a need of lower profile.

FIG. 1D illustrates another camera module connector 8 in the prior art, which is disclosed in Chinese patent granted No. CN 2745249Y. The camera module connector 8 has a clamping casing 80 formed of four clamping plates 81 which are latched together. A side of a top end of the each clamping plate 81 is bent downwardly toward a receiving space to form an abut-press piece 82 and an abut-squeeze piece 83, wherein a free end of the abut-press piece 82 is bent toward the clamping plate 81 to form the abut-press piece 82 with a latching hook shape, a free end of the abut-squeeze piece 83 is bent toward the receiving space to form the abut-squeeze piece 83 with resilience. The clamping casing 80 may be assembled to an insulative housing 85 and terminals 86 may be assembled into terminal grooves in the insulative housing 85. During assembling, a lens module is inserted downwardly toward an insertion space 84, a side wall of a base of the lens module outwardly abuts and pushes against an abut-push portion 861 of the terminal 86 and the abut-squeeze piece 83 of the clamping casing 80 firstly so as to make the camera module connector 8 and the lens module not move relatively. When the abut-press piece 82 of the clamping casing 80 is inserted into an abut-press groove in a top surface of the lens module, the abut-press piece 82 with the latching hook shape downwardly abuts and pushes against a wall surface of the base where the abut-press groove is present, consequently the camera module connector 8 tightly abuts against the lens module in a vertical direction and relative movement of them does not occur.

As shown in FIG. 1D, the abut-press piece 82 and the abut-squeeze piece 83 in each pair are provided separately, they have no linkage relationship with each other. In other words, the abut-squeeze piece 83 cannot constrain a rebound movement of the abut-press piece 82. The rebound movement of the abut-press piece 82 is not constrained, therefore after the lens module is inserted, the abut-press piece 82 would rebound to a position where lens module is not inserted. Consequently, similar to the above camera module connector 1, the camera module connector 8 need a relative big mounting allowance to mount the lens module and it is difficult to meet need of lower profile due to a high height of the camera module connector 8.

### SUMMARY

The present application discloses an electrical connector that can be formed with a receiving space having an opening opened upwardly and the electrical connector comprises an insulative body, a plurality of terminals and a metal shell. The terminals can be fixed to the insulative body. The metal shell is mounted to the insulative body. The metal shell comprises a resilient piece, the resilient piece protrudedly extends toward the receiving space, a distal end of the resilient piece comprises a first tab and a second tab, the first tab and the second tab extend downwardly respectively, the first tab is offset toward inside of the receiving space relative to the second tab, and an end edge of the second tab is lower than an end edge of the first tab.

In another embodiment an electrical connector is configured to receive a camera module with a receiving space having an opening opened upwardly. The camera module comprises a plurality of electrical contacts, a stopping surface facing upwardly and a side wall under the stopping surface. The electrical connector comprises an insulative body, a plurality of terminals and a metal shell. The terminals are fixed to the insulative body and electrically connect the electrical contacts of the camera module respectively. The metal shell is mounted to the insulative body. The metal shell comprises a resilient piece, the resilient piece protrudedly extends toward the receiving space. A distal end of the resilient piece comprises a first tab and a second tab, the first tab and the second tab extend downwardly respectively. The first tab is offset toward inside of the receiving space relative to the second tab, and an end edge of the second tab is lower than an end edge of the first tab. When the camera module is not inserted, the end edge of the first tab is positioned at an initial position; after the camera module is inserted, the second tab tightly abuts against the side wall of the camera module, and the end edge of the first tab abuts against the stopping surface of the camera module at a position which is lower than the initial position.

### BRIEF DESCRIPTION OF THE FIGURES

FIG. 1A illustrates an embodiment of a camera module connector and a latch element thereof in the prior art in a first position;

FIG. 1B illustrates an embodiment of a camera module connector and a latch element thereof in the prior art in a second position;

FIG. 1C illustrates an embodiment of a camera module connector and a latch element thereof in the prior art in a third position;

FIG. 1D illustrates a perspective view of another camera module connector in the prior art;

FIG. 2 is a perspective view of an embodiment of the present application which illustrates an electrical connector mounted to a circuit board and receiving the camera module;

FIG. 3 is a perspective view of the electrical connector mounted to the circuit board of the embodiment of the present application;

FIG. 4 is another perspective view of the electrical connector mounted to the circuit board of the embodiment of the present application;

FIG. 5 is an exploded view of the embodiment of FIG. 2;

FIG. 6 is another exploded view of the embodiment of FIG. 2;

FIG. 7 is a cross sectional view of the embodiment of the present application which illustrates a first tab in a recessed groove and a second tab abutting against a side wall of the camera module;

FIG. 8 is a cross sectional view of the camera module and the electrical connector of the embodiment of the present application which are separated;

FIG. 9 is a cross sectional view of the embodiment of the present application which illustrates the camera module is being assembled to the electrical connector;

FIG. 10 is a cross sectional view of the camera module of the electrical connector and the electrical connector of the embodiment of the present application which has been assembled;

FIG. 11 is a cross sectional view of an embodiment of the present application which illustrates the first tab in the recessed groove and the second tab tightly abutting against the side wall of the camera module;

FIG. 12A is a cross-sectional view of an embodiment of a connector with a resilient member prior to insertion of a housing.

FIG. 12B is a cross-sectional view of the embodiment of FIG. 12A during insertion of the housing.

FIG. 12C is a cross-sectional view of the embodiment of FIG. 12A after insertion of the housing.

FIG. 12D is a simplified schematic diagram which illustrates angle change of the resilient piece and position change of an end edge of the first tab during insertion of the camera module.

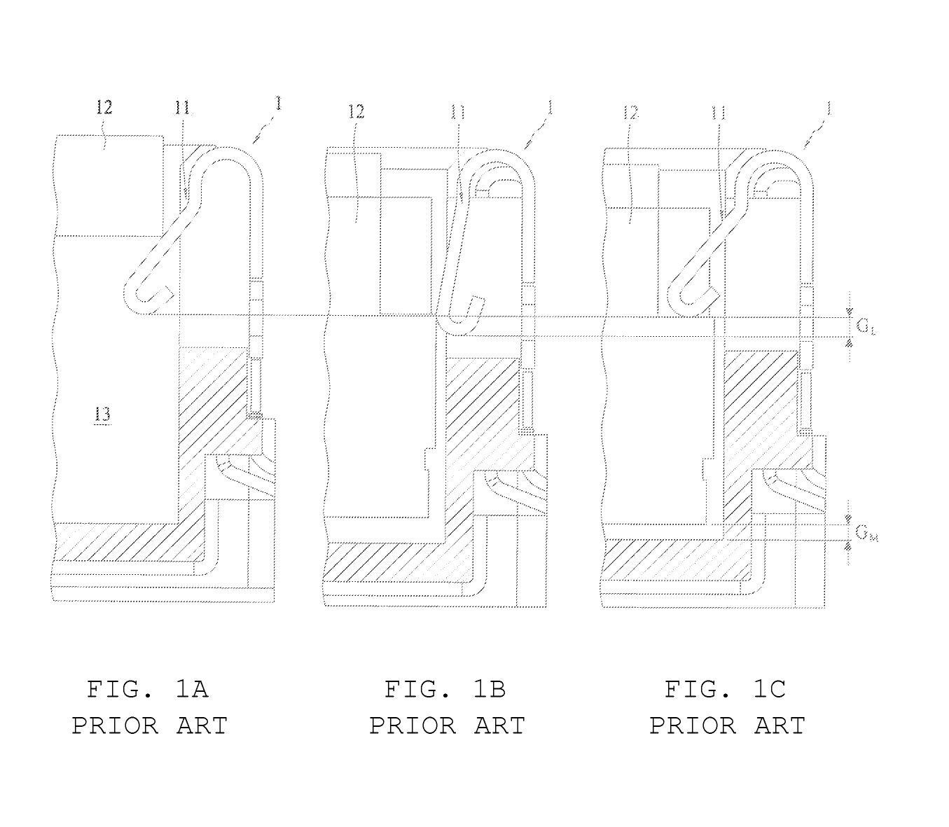

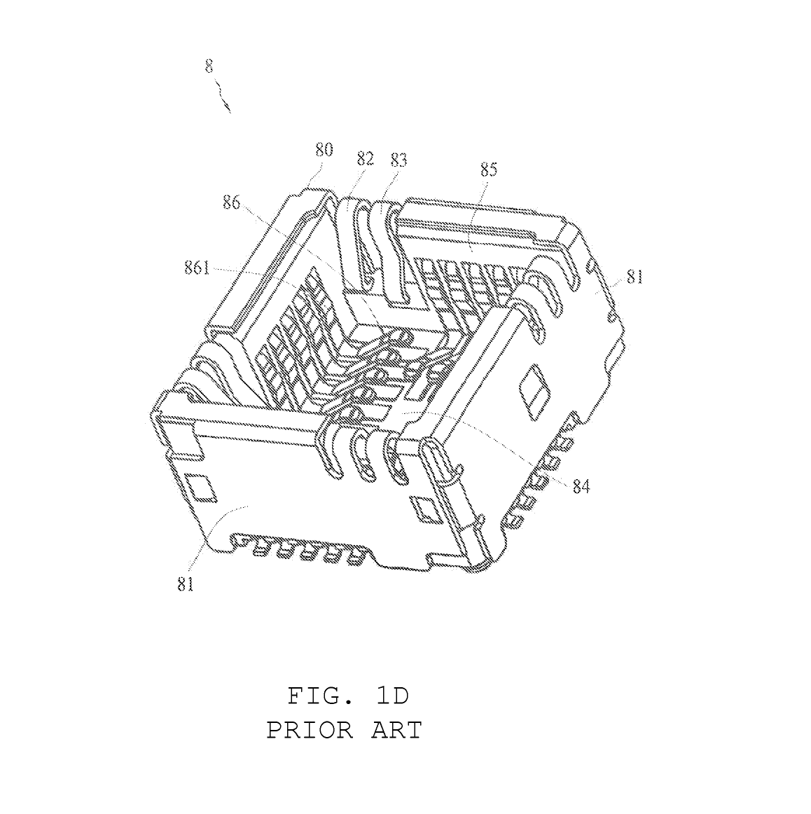

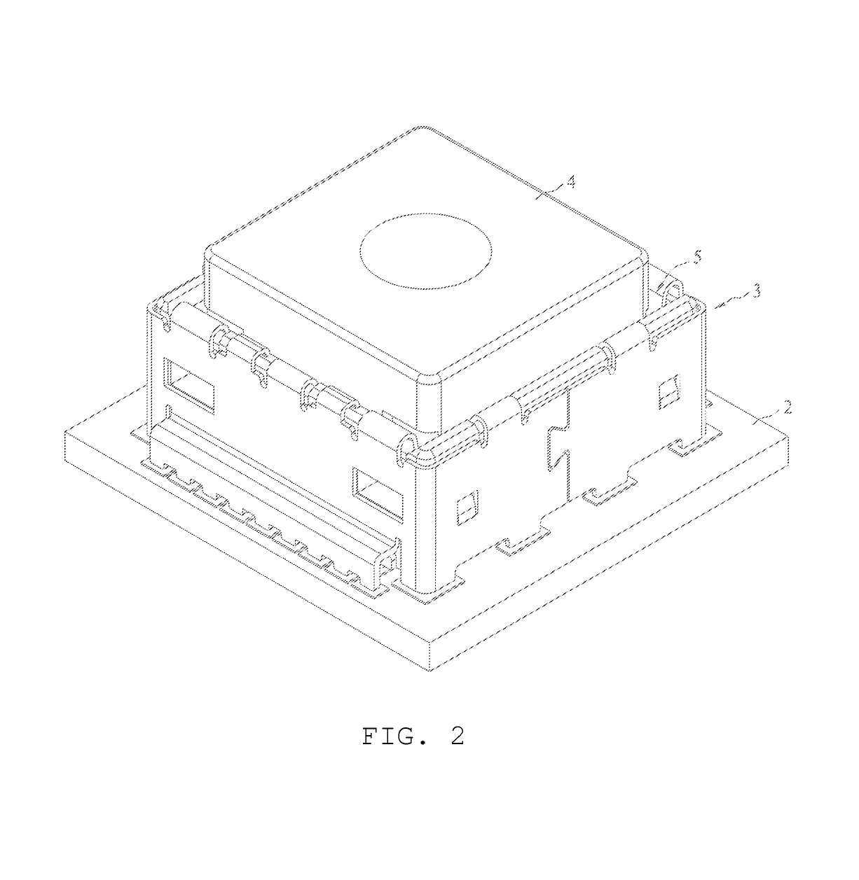

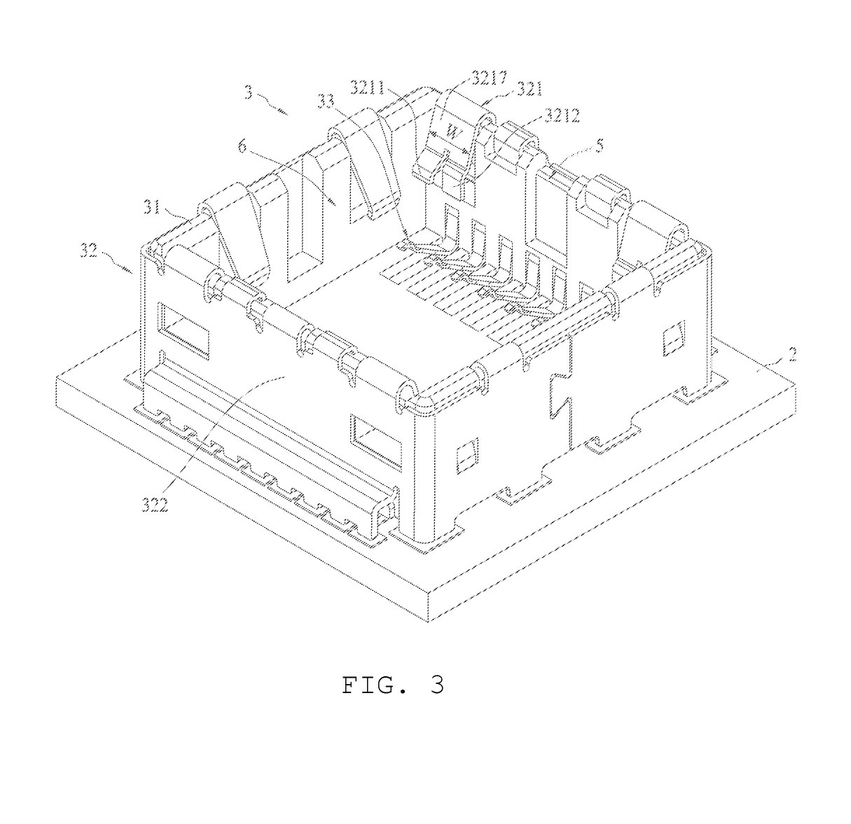

### DESCRIPTION OF THE PREFERRED EMBODIMENTS

Hereinafter embodiments of the present application are described in details in combination with the drawings. The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

As discussed below, an electrical connector is configured to receive a camera module and includes a resilient piece. Because the resilient piece comprises a first tab and a second tab extending downwardly respectively, the first tab is offset toward inside of a receiving space relative to the second tab, and an end edge of the first tab is higher than an end edge of the second tab, so the a distance of upward rebound of the camera module may be reduced, a reserve space between the camera module and the electrical connector after mounting is reduced, and a profile of the electrical connector is reduced. Thus, the depicted embodiments can help provide a lower profile camera module.

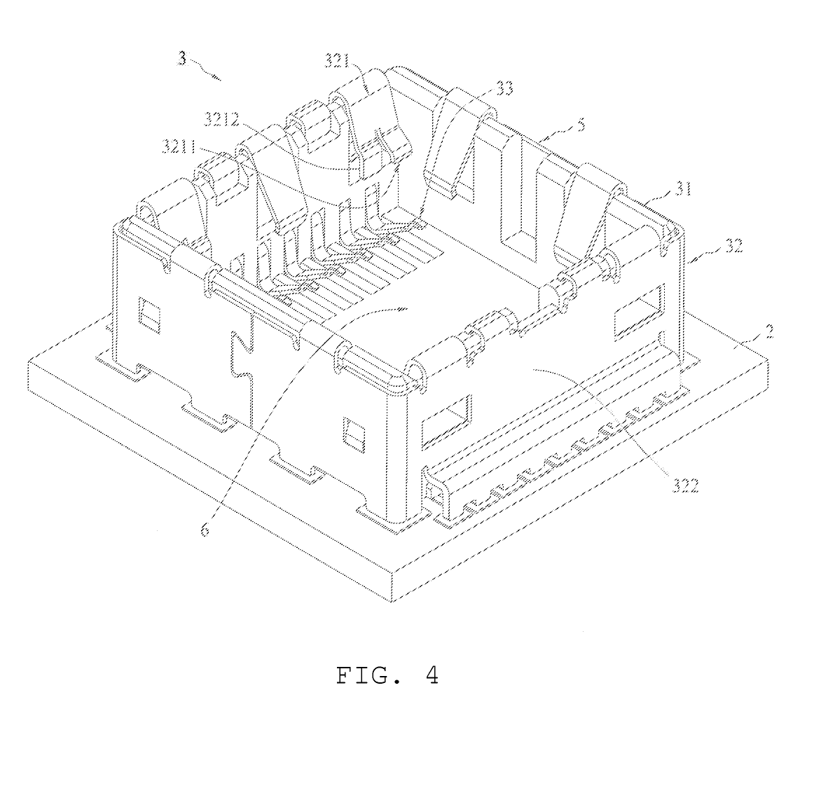

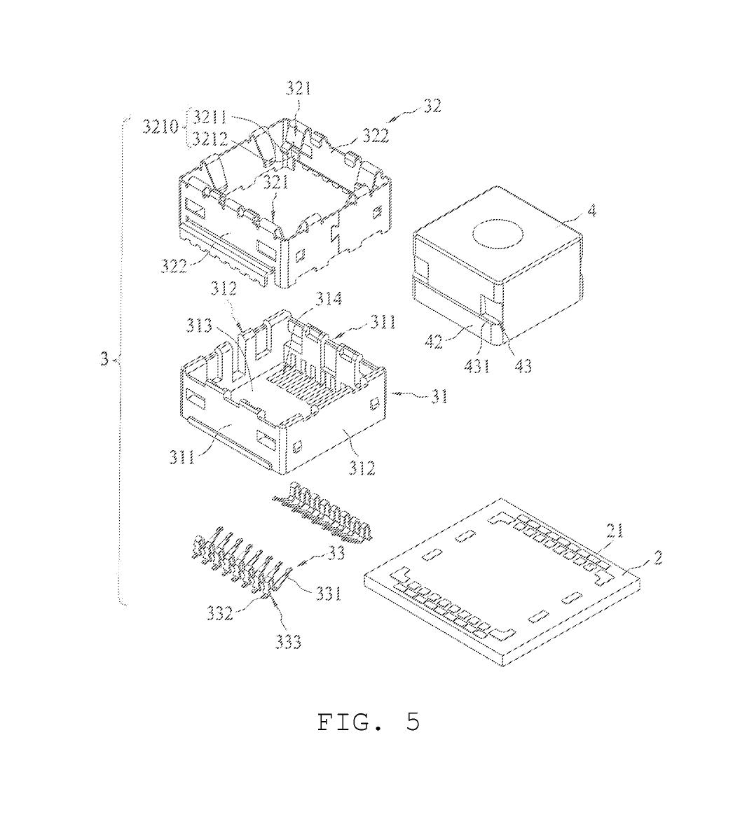

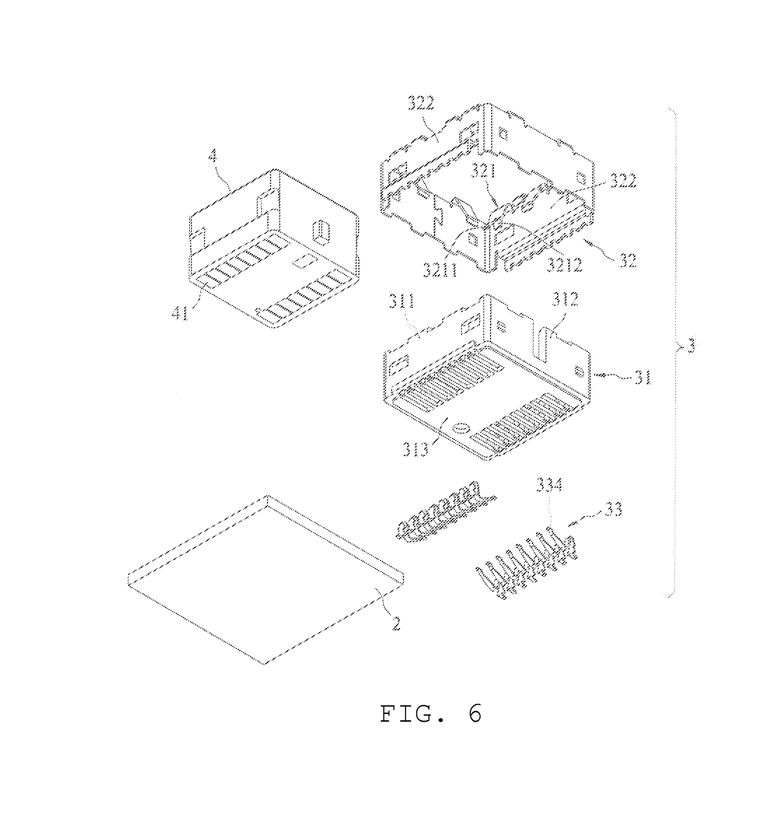

FIG. 2 is a perspective view of an embodiment of the present application which illustrates an electrical connector 3 mounted to a circuit board 2 and receiving a camera module 4. FIG. 3 is a perspective view of the electrical connector 3 of the embodiment of the present application which is mounted to the circuit board 2. FIG. 4 is another perspective view of the electrical connector 3 of the embodiment of the present application which is mounted to the circuit board 2. FIG. 5 is an exploded view of the embodiment of FIG. 2. FIG. 6 is another exploded view of the embodiment of FIG. 2. Referring to FIGS. 2-6, an electrical connector 3 is configured to mount on a circuit board 2 and may receive a camera module 4 with a receiving space 6 having an opening 5 opened upwardly.

Referring to FIGS. 3-6, the electrical connector 3 may comprise an insulative body 31, a metal shell 32 and a plurality of terminals 33, wherein the terminals 33 are fixed to the insulative body 31 and the metal shell 32 is mounted to the insulative body 31. The insulative body 31 may be a groove-shape, which has a plurality of side walls and a bottom wall 313. Preferably, in the present embodiment, the insulative body 31 comprises four side walls 311 and 312, wherein the camera module 4 may be inserted into the receiving space 6 among the four side walls 311 and 312 and the bottom wall 313. Two opposite ends of the bottom wall 313 are respectively connected to the opposite side walls 311, a plurality of terminal grooves 314 are formed in the two opposite ends and extend to the side walls 311, the terminals 33 are respectively inserted into the terminal grooves 314.

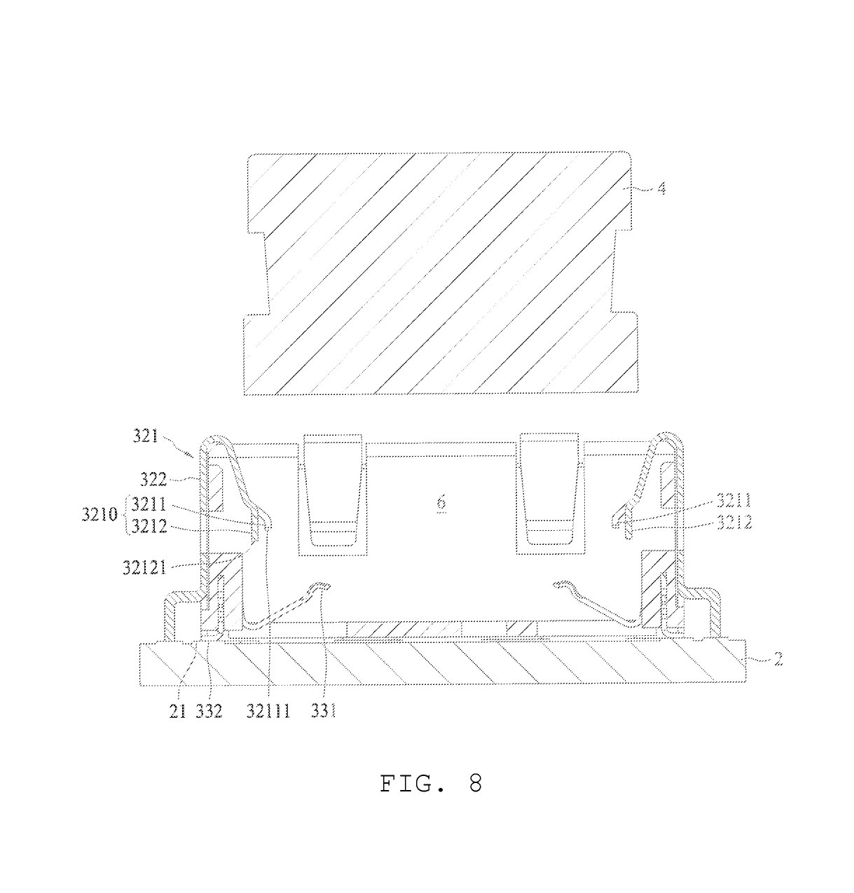

As shown in FIG. 5, the each terminal 33 comprises a resilient arm 331, a soldering portion 332 and a fixed portion 333, wherein the fixed portion 333 extends between the resilient arm 331 and the soldering portion 332. After the terminal 33 is assembled, the resilient arm 331 of the terminal 33 protrudedly extends into the receiving space 6 (FIG. 8) to electrically connect the camera module 4 received; the soldering portion 332 of the terminal 33 extends under the corresponding side wall 311 to be soldered to a corresponding soldering pad 21 (FIG. 5 and FIG. 8) on the circuit board 2; and the fixed portion 333 of the terminal 33 may have a barb, which is interferentially engaged with corresponding walls of the terminal groove 314 to fix the terminal 33.

Referring to FIG. 6, the camera module 4 may comprise a plurality of electrical contacts 41, wherein the electrical contacts 41 are provided respectively to correspond to the contact portions 334 of the resilient arms 331 of the terminals 33. After the camera module 4 is inserted, the each electrical contact 41 is electrically connected to the contact portion 334 of the corresponding resilient arm 331.

Referring to FIGS. 3-6, the metal shell 32 comprises at least a resilient piece 321, which protrudedly extends toward the receiving space 6. In an embodiment, at least a resilient piece 321 may be bent downwardly into the receiving space 6 from a top edge of the metal shell 32. In an embodiment, the metal shell 32 comprises a plurality of side plates 322, wherein at least a resilient piece 321 extends downwardly into the receiving space 6 from a top edge of one side plates 322. In an embodiment, the metal shell 32 comprises two opposite side plates 322 and a plurality of resilient pieces 321, wherein at least a resilient piece 321 extends downwardly into the receiving space 6 from the each side plate 322. In an embodiment, the metal shell 32 comprises two opposite side plates 322 and a plurality of resilient pieces 321, wherein two resilient pieces 321 extends into the receiving space 6 from the each side plate 322.

Referring to FIG. 5, FIG. 6 and FIG. 8, a distal end 3210 of the resilient piece 321 comprises a first tab 3211 and a second tab 3212, which extend downwardly respectively, wherein, the first tab 3211 is offset toward inside of the receiving space 6 relative to the second tab 3212 or the first tab 3211 is close to a central of the receiving space 6 relative to the second tab 3212, and an end edge 32121 of the second tab 3212 is lower than an end edge 32111 of the first tab 3211. Because the distal end 3210 of the resilient piece 321 is formed with the first tab 3211 and the second tab 3212, the first tab 3211 and the second tab 3212 may link. In other words, movement of the first tab 3211 would cause movement of the resilient piece 321, and the movement of the resilient piece 321 would drive the second tab 3212 to move. Similarly, movement of the second tab 3212 would cause movement of the resilient piece 321, and in turn drive the first tab 3211 to move. Furthermore, the resilient piece 321 have resilience, which can be abutted and pressed outwardly and can rebound to make the end edge 32111 of the first tab 3211 return to an initial position or an initial height of the resilient piece 321 which is not pressed when an abut-press force is removed; but the second tab 3212 is formed to limit a rebound degree of the resilient piece 321 or limit a height of the end edge 32111 of the first tab 3211 after the resilient piece 321 rebounds, thereby making the end edge 32111 of the first tab 3211 not rebound to the initial position or the initial height.

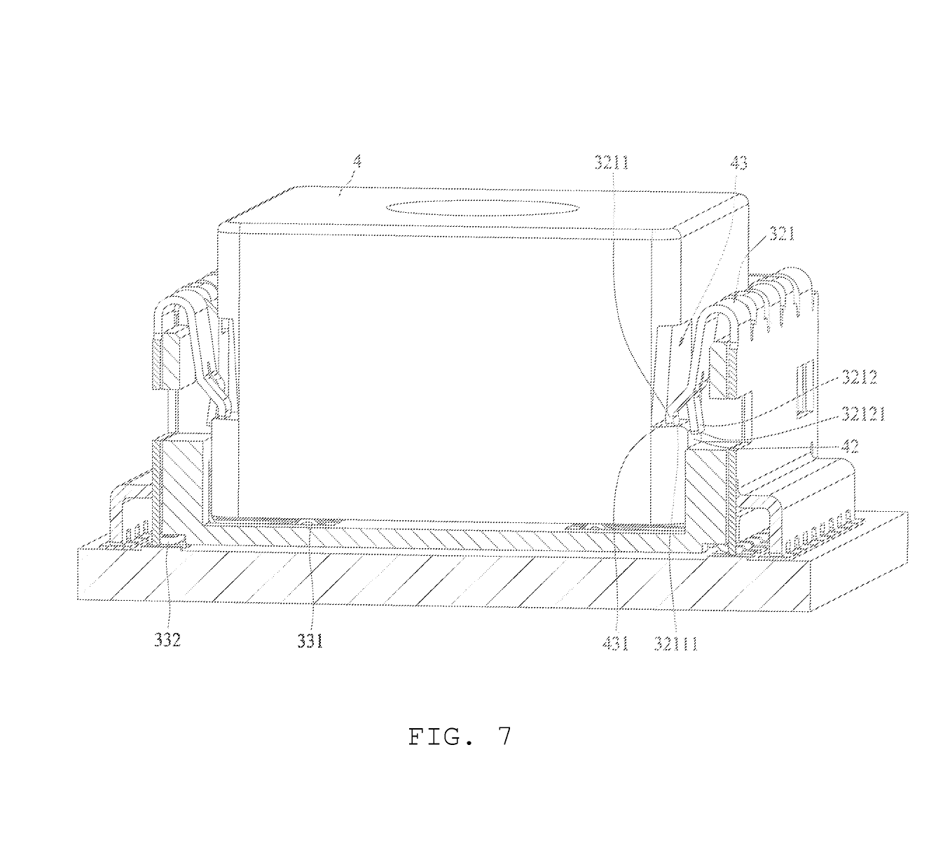

Referring to FIG. 5, corresponding to the resilient piece 321, the camera module 4 may be formed with a recessed groove 43, a bottom of the recessed groove 43 is defined by a stopping surface 431 facing upwardly, a side wall 42 of the camera module 4 is under the stopping surface 431. As shown in FIG. 7 and FIG. 8, in the present embodiment, preferably, the distal end 3210 of the resilient piece 321 extends downwardly, so after the camera module 4 is inserted into the receiving space 6, the end edge 32111 of the first tab 3211 of the resilient piece 321 is positioned on the stopping surface 431 of the camera module 4 and the second tab 3212 of the resilient piece 321 tightly abuts against the side wall 42 of the camera module 4.

Referring to FIG. 3, preferably, the resilient piece 321 may comprise a body portion 3217, to which the first tab 3211 and the second tab 3212 are connected. A width W of the body portion 3217 is greater than a sum of a width of the first tab 3211 and a width of the second tab 3212, thereby making the body portion 3217 have a wide plate shape, therefore the body portion 3217 has a better stiffness capable of retaining the camera module 4 stably. Furthermore, both of the widths of the first tab 3211 and the second tab 3212 and the width of the body portion 3217 may be adjusted, therefore the present application cannot be limited to the above embodiment.

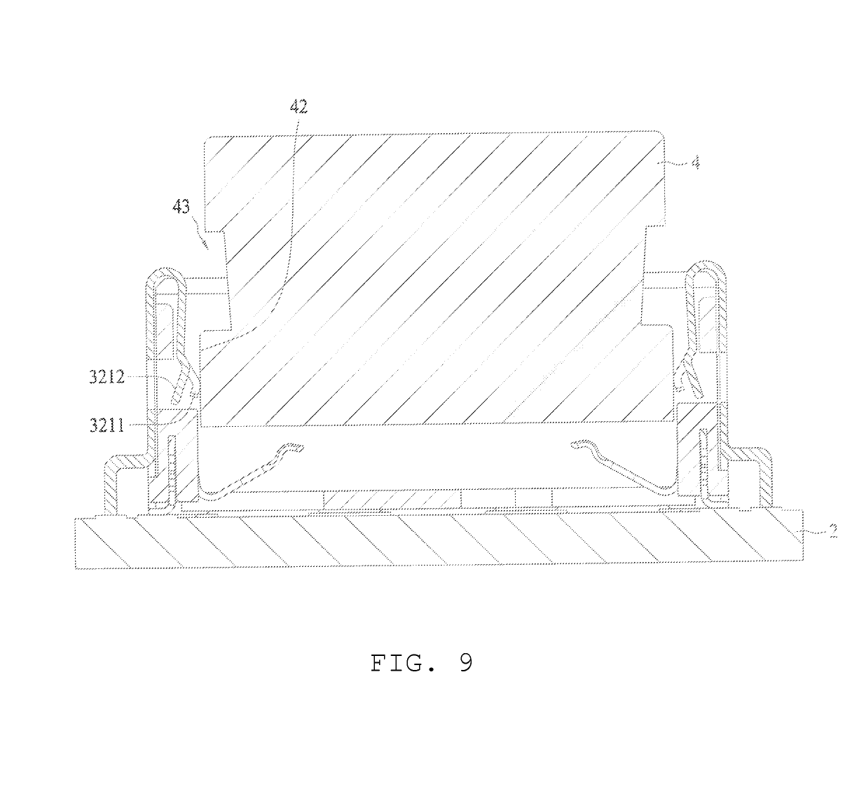

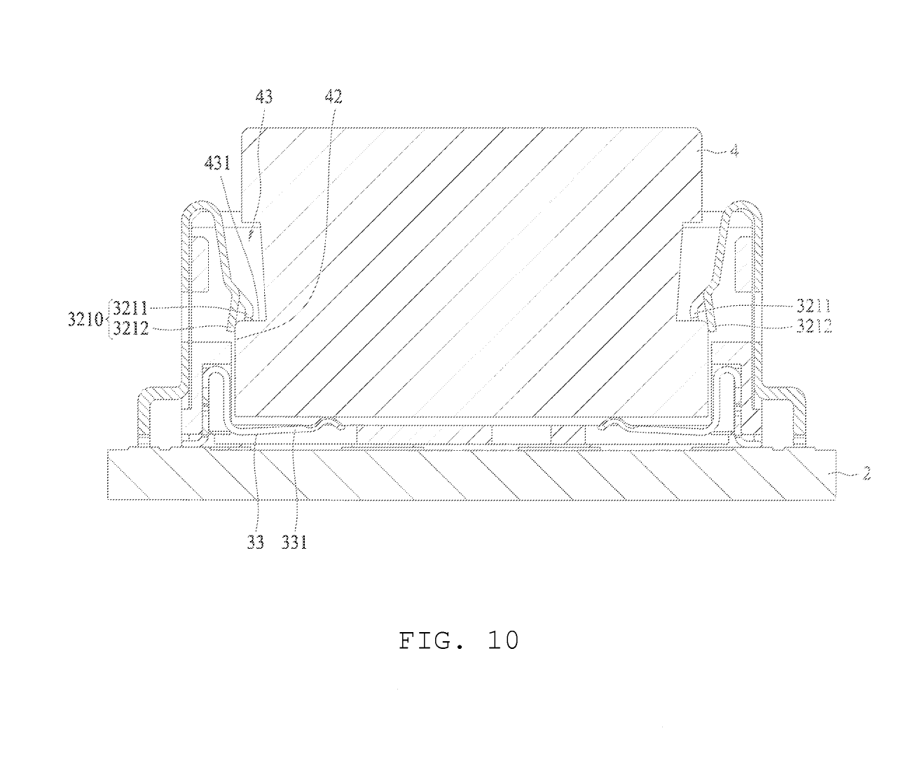

Referring to FIG. 8, before the camera module 4 is inserted into the receiving space 6, the resilient piece 321 bends and extends obliquely and downwardly toward the receiving space 6 from the corresponding side plate 322, wherein the first tab 3211 and the second tab 3212 of the resilient piece 321 are positioned in the receiving space 6. Referring to FIG. 8 and FIG. 9, during insertion of the camera module 4, when a bottom edge of the camera module 4 contacts the resilient piece 321, the resilient piece 321 begins to be pushed and moved outwardly. In subsequent insertion, the resilient piece 321 would be pushed away from an inserting path of the camera module 4, and then the first tab 3211 of the resilient piece 321 would in turn abut against the side wall 42 of the camera module 4. Due to the linkage relationship, the second tab 3212 would be also moved outwardly. Referring to FIG. 10, when the recessed groove 43 of the camera module 4 gets close to the distal end 3210 of the resilient piece 321 and an outward push force imposed on the resilient piece 321 by the camera module 4 is not present, a resilience of the resilient piece 321 would make the first tab 3211 move toward inside of the recessed grooves 43 until the second tab 3212 tightly abuts against the side wall 42 of the camera module 4. Because the resilient arm 331 of the terminal 33 under the camera module 4 is pressed downwardly, an upward push force would be produced. When a downward press force used to mount the camera module 4 is removed, the camera module 4 would slightly rebound until the end edge 32111 of the first tab 3211 abuts against the stopping surface 431 of the camera module 4 facing upwardly.

Referring to FIG. 8, FIG. 10 and FIG. 11, the structures, that the first tab 3211 of the resilient piece 321 is offset toward inside of the receiving space 6 relative to the second tab 3212 and the end edge 32121 of the second tab 3212 is lower than the end edge 32111 of the first tab 3211, makes a distance of upward rebound of the camera module 4 small when the downward press force assembling the camera module 4 is removed. That rebound is little when the camera module 4 is mounted shows that downward press of the resilient arm 331 of the terminal 33 is still bigger and thus bigger upward push force is produced, therefore contact between the contact portion 334 of the terminal 33 and the electrical contact 41 of the camera module 4 may be closer to obtain an effect of more reliable electrical contact.

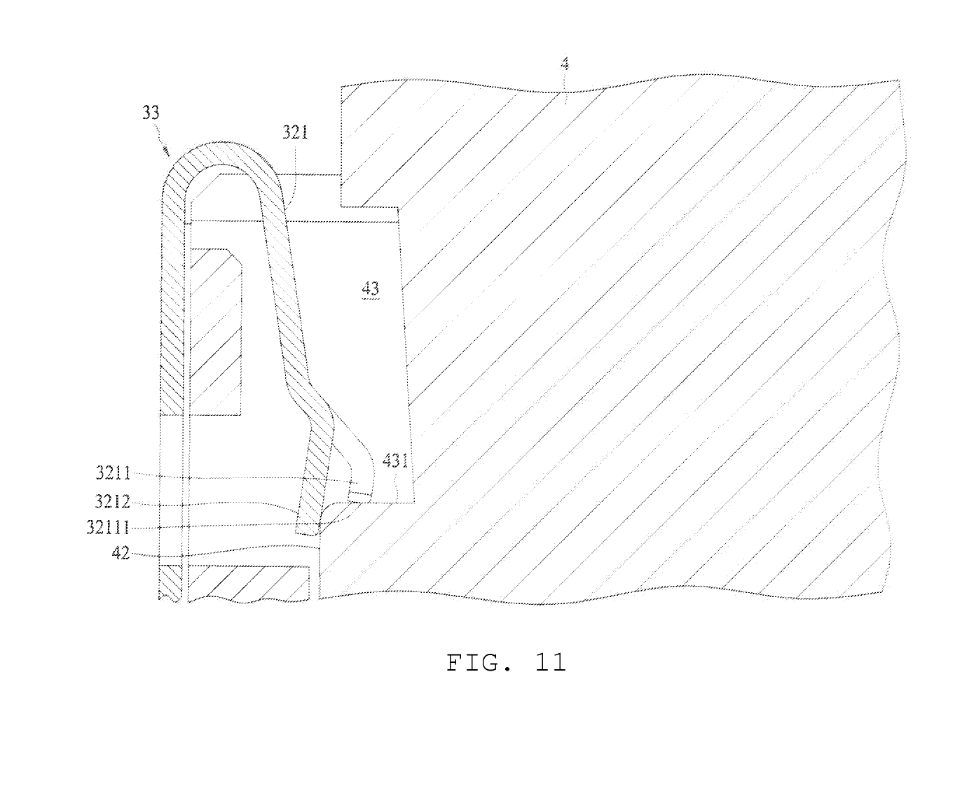

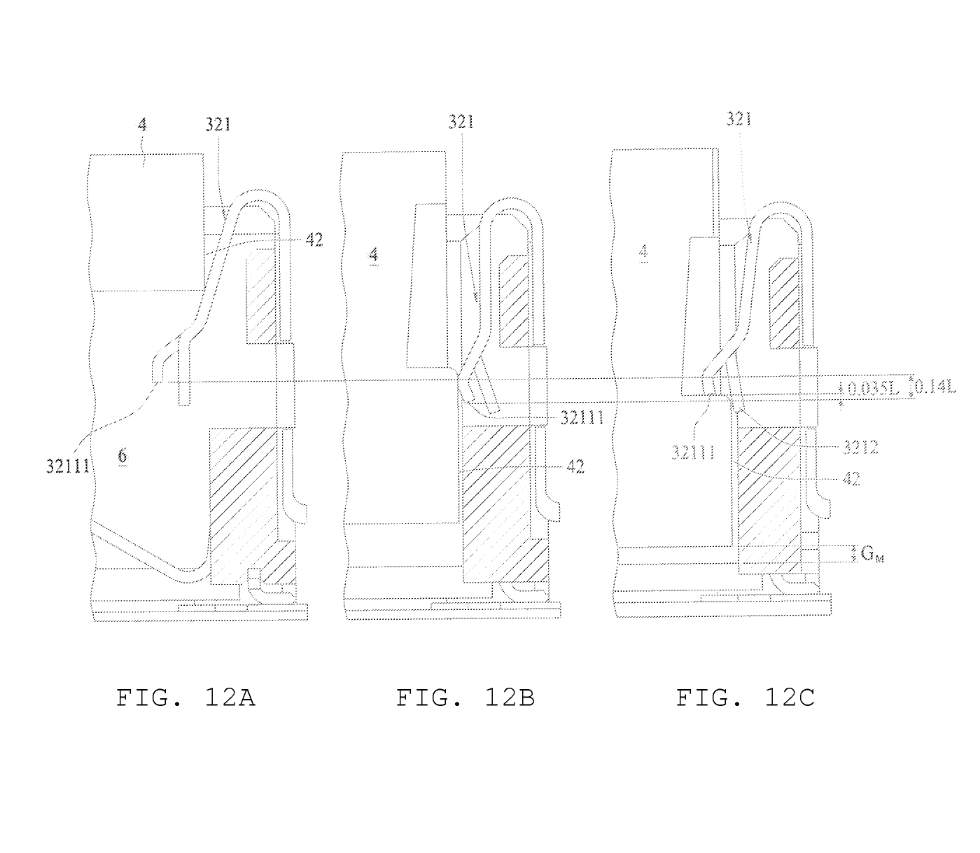

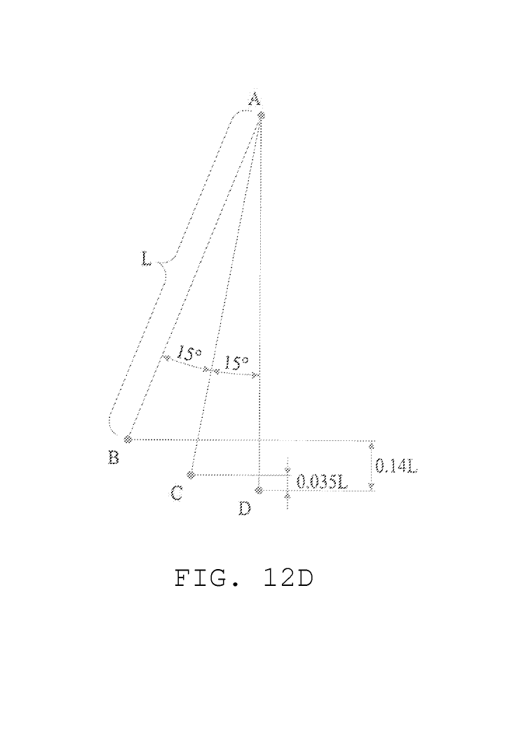

FIGS. 12A-12C are schematic cross-section representations of an embodiment of the present application which illustrate change of the resilient piece 321 when the camera module 4 is assembled. FIG. 12D is a simplified schematic diagram which illustrates angel change of the resilient piece 321 and position change of the end edge 32111 of the first tab 3211 when the camera module 4 is inserted. When the camera module 4 is inserted, the first tab 3211 is abutted and pressed to push the resilient pieces 321 outwardly. When the first tab 3211 would not be subjected to the abut-press force from the camera module 4 inserting, the resilient piece 321 rebounds, the first tab 3211 begins to move and the second tab 3212 also moves with the first tab 3211. When the second tab 3212 abuts against the camera module 4, the first tab 3211 is constrained to stop movement, therefore the first tab 3211 cannot return a position where the resilient piece 321 is not subjected to the abut-press force, thereby making the end edge 32111 of the first tab 3211 move to a lower position.

Specially referring to FIG. 12A and FIG. 12D, before the camera module 4 is inserted into the receiving space 6, the resilient piece 321 extend obliquely and downwardly toward the receiving space 6. A length of the resilient pieces 321 is defined as L, B point (FIG. 12D) is represented as an initial position of the end edge 32111 of the first tab 3211. Referring to FIG. 12B and FIG. 12D, when the camera module 4 is further inserted, the resilient piece 321 would abut against the side wall 42 of the camera module 4, the resilient piece 321 is regarded as that the resilient piece 321 rotates to a position of D point of the end edge 32111 of the first tab 3211 around A point. In an embodiment, the resilient pieces 321 may rotate 30 degrees, so a vertical distance between B point and D point is about 0.14L. Referring to FIG. 12C and FIG. 12D, when the camera module 4 further move downwardly and the first tab 3211 of the resilient pieces 321 no longer abuts against the side wall 42 of the camera module 4, the first tab 3211 would move back. The first tab 3211 and the second tab 3212 are in the linkage relationship, therefore when the first tab 3211 moves, the second tab 3212 also moves with it, the first tab 3211 moves until the second tab 3212 tightly abuts against the side wall 42 of the camera module 4. At this time, the end edge 32111 of the first tab 3211 of the resilient piece 321 would move from D point to point C. The rebound angle is small, therefore a distance of upward rebound is small, and the end edge 32111 of the first tab 3211 at the C point is lower the above initial position. In an embodiment, the rebound angle of the resilient piece 321 is about 15 degrees, which makes a rebound distance (that is, the vertical distance between C point and D point) be about 0.035L. Because 0.035L of rebound distance is small or the end edge 32111 of the first tab 3211 is lower than the above initial position, thereby correspondingly reducing mounting allowance and reducing a reserve space G_{M} between the bottom wall 313 and a bottom surface of the camera module 4 so as to reduce a profile of the electrical connector 3. Both the above angles and lengths are described as hypotheses, so the present application is not limited to the sizes.

The embodiments of the present application disclose an electrical connector which comprises an insulative body and a metal shell. The electrical connector is formed with a receiving space to receive the camera module. The insulative body is fixedly provided with a plurality of terminals. The metal shell comprises a resilient piece protrudedly extending toward the receiving space. The resilient piece comprises a first tab and a second tab extending downwardly respectively. The first tab is formed to be offset toward inside of the receiving space relative to the second tab, and an end edge of the first tab is higher than an end edge of the second tab. As such, a distance of upward rebound of the camera module is small, thereby reducing a height of the camera module and making contact between the contact portion of the terminal and the electrical contact of the camera module closer so as to obtain the effect of more reliable electrical contact.

The technical contents and technical features of the present application have been disclosed as above, however a person skilled in the art may still make substitutions and modifications without departing from the spirit of the present application according to teaching and disclosure of the present application. Thus, the protective scope of the present application should not be limited to the disclosed embodiments, but should include various substitutions and modifications without departing from the present application and these substitutions and modifications are covered by the claims.

What is claimed is:

1. An electrical connector, formed with a receiving space having an opening opened upwardly, the electrical connector comprising:
an insulative body;
a plurality of terminals fixed to the insulative body; and
a metal shell mounted to the insulative body, the metal shell comprising a resilient piece, the resilient piece protrudedly extending toward the receiving space, a distal end of the resilient piece comprising a first tab and a second tab, the first tab and the second tab extending downwardly respectively, the first tab being offset toward inside of the receiving space relative to the second tab, and an end edge of the second tab being lower than an end edge of the first tab.

2. The electrical connector according to claim 1, wherein movement of the first tab would cause movement of the resilient piece, and the movement of the resilient piece would drive the second tab to move; and, movement of the second tab would cause movement of the resilient piece, and in turn drive the first tab to move.

3. The electrical connector according to claim 1, wherein the resilient piece comprises a body portion, the first tab and the second tab are connected to the body portion, a width of the body portion is larger than a sum of a width of the first tab and a width of the second tab.

4. The electrical connector according to claim 1, wherein the metal shell comprises a plurality of side plates, the resilient piece extends downwardly into the receiving space from a top edge of the one side plate.

5. An electrical connector, configured to receive a camera module with a receiving space having an opening opened upwardly, the camera module comprising a plurality of electrical contacts, a stopping surface facing upwardly and a side wall under the stopping surface, the electrical connector comprising:
an insulative body;
a plurality of terminals fixed to the insulative body and electrically connecting the electrical contacts of the camera module respectively; and
a metal shell mounted to the insulative body, the metal shell comprising a resilient piece, the resilient piece protrudedly extending toward the receiving space, a distal end of the resilient piece comprising a first tab and a second tab, the first tab and the second tab extending downwardly respectively, the first tab being offset toward inside of the receiving space relative to the second tab, and an end edge of the second tab being lower than an end edge of the first tab;
when the camera module is not inserted, the end edge of the first tab being positioned at an initial position; after the camera module is inserted, the second tab tightly abutting against the side wall of the camera module, and the end edge of the first tab abutting against the stopping surface of the camera module at a position which is lower than the initial position.

6. The electrical connector according to claim 5, wherein movement of the first tab would cause movement of the resilient piece, and the movement of the resilient piece would drive the second tab to move; and, movement of the second tab would cause movement of the resilient piece, and in turn drive the first tab to move.

7. The electrical connector according to claim 5, wherein the resilient piece comprises a body portion, the first tab and the second tab are connected to the body portion, a width of the body portion is larger than a sum of a width of the first tab and a width of the second tab.

8. The electrical connector according to claim 5, wherein the metal shell comprises a plurality of side plates, the resilient piece extends downwardly into the receiving space from a top edge of the one side plate.
